(19) United States
(12) Patent Application Publication
(10) Pub. No.: US 2005/0135704 A1
(43) Pub. Date: Jun. 23, 2005

(54) Scanned image generating device and a method thereof and a pollution occurrence judging device thereof

(75) Inventor: Seok-Ho Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/960,980

(22) Filed: Oct. 12, 2004

(30) Foreign Application Priority Data
Dec. 22, 2003 (KR) 2003-94705

(51) Int. Cl. G06K 9/34

(52) U.S. Cl. 382/275

(57) ABSTRACT

A scanned image generating device, including a shading data calculation part to calculate shading data by scanning a white sheet, an average calculation part to calculate an average between an object pixel and neighboring pixels of the object pixel based on the shading data calculated by the shading data calculation part, a comparison part to compare a value of the object pixel, calculated by the shading data calculation part, to the average of values of the neighboring pixels, calculated by the average calculation part, an adjustable processing part to adjust the object pixel value calculated by the average calculation part, according to a result of comparison of the comparison part, and a filtering post-processing part such that the object pixel value adjusted by the adjustable processing part gradually changes with respect to the values of the neighboring pixels. Accordingly, the scanned image generating device may restrain influences of contamination such as dust or foreign substances occurring on a certain spot of a line, thereby enabling a high-quality image to be produced.

### CROSS-REFERENCE TO RELATED APPLICATION

This application claims the benefit of Korean Application No. 2003-94705, filed Dec. 22, 2003, in the Korean Intellectual Property Office, the disclosure of which is incorporated herein by reference.

### BACKGROUND OF THE INVENTION

1. Field of the Invention

The present invention relates to a device to remove a black line that is produced while forming a scanned image by a scanned image generating device, and a method of removing a black line that is produced while forming a scanned image. More particularly, the present invention relates to a scanned image generating device that is capable of removing a black line that is produced while forming a scanned image using white-shading correction, a method of removing a black line produced while forming a scanned image using white-shading correction, and a pollution occurrence judging device of the scanned image generating device.

2. Description of the Related Art

In general, scanned image generating devices such as digital multi-operation peripherals (MFPs), facsimiles, photocopiers, and image scanners comprise an image sensor such as a charge coupled device (CCD), and a contact image sensor (CIS). The scanned image generating devices also comprise a motor to vertically move the image sensor in a line unit.

FIG. 1 schematically shows the structure of a general scanned image generating device, and FIG. 2 schematically shows a conveyance path to transfer a document of the scanned image generating device of FIG. 1.

A scanner is a device that detects data that is recorded on a document by a unit of reading width, for example, by 1 line or 1 band, and converts the data to an electric signal. Referring to FIGS. 1 and 2, the scanner comprises a scanning head 102 disposed at a predetermined distance from a valid reading area to scan image information recorded on the document 101, a guide rail 103 to guide a horizontal movement of the scanning head 102, a carriage return motor 104 to supply a driving force of the scanning head 102 to move in a horizontal direction, a transfer belt 105 to transmit the driving force of the carriage return motor 104 to the scanning head 102, a pickup roller 107 to pick up the document 101 stacked on a cassette 106 and to insert the document 101 to the document transferring path, a driving roller 108 to transfer document 101 picked up by the pickup roller 107 to the valid reading area of the scanning head 102, a discharge roller 109 to discharge the document 101 when scanning work is completed, and a standard sheet 110. The standard sheet 110 is located within a movement range of the scanning head 102, is attached on a position out of range of the valid reading area of the scanning head 102, and is recorded with a standard pattern of a predetermined form so that the scanning head 102 may read the data.

The scanning head 102 has a lamp 111 at its end, and a light, which is emitted from the lamp 111, is scanned on the document 101. The scanning head 102 is provided with a CCD 112 to convert the light reflected from the document 101 to electric data. Between the lamp 111 and the CCD 112, a lens 113 focuses the light reflected from the document 101 so that the reflected light reaches a predetermined area of the CCD 112. The lamp 111, the CCD 112, and the lens 113 may be integrally formed.

The scanner has a scanning width set for one scanning iteration. An example of a scanning area is shown in FIG. 3, the scanning area being allowed for a general scanning head to scan at one time.

A mono-type scanner may scan an area of width 1 pixel [symbol] length 128 pixels, and a color-type scanning head may scan an area of width 1 pixel [symbol] length 160 pixels. In FIG. 3, the mono-type scanning head is illustrated, in which the scanning head 102 scans consecutively from a first pixel to a last pixel as much as width 1 pixel [symbol] length 128 pixels during one time of scanning operation.

However, in the scanned image generating device which receives an image by lines, if a foreign substance such as dust or dirt exists on a certain spot on the line, regardless of a state of the document 101, a black line is generated on the document 101 which is outputted after completion of the scanning operation. The black line causes a decrease in the legibility of letters or images and also deteriorates a quality of the image.

### SUMMARY OF THE INVENTION

Therefore, an aspect of the present invention provides a scanned image generating device which is able to generate a high-quality scanned image, by effectively removing an influence of contamination such as dust or foreign substances on a certain spot of a line, and a method thereof, and a pollution occurrence judging device to be used with the scanned image generating device.

In order to achieve the above and/or other aspects of the present invention, a scanned image generating device comprises a shading data calculation part to calculate shading data by scanning a white standard sheet, an average calculation part to calculate an average between an object pixel and neighboring pixels of the object pixel based on the shading data calculated by the shading data calculation part, a comparison part to compare a value of the object pixel, calculated by the shading data calculation part, to the average of values of the neighboring pixels, calculated by the average calculation part, an adjustable processing part to adjust the object pixel value calculated by the average calculation part, according to a result of comparison of the comparison part, and a filtering post-processing part such that the object pixel value adjusted by the adjustable processing part gradually changes with respect to the values of the neighboring pixels.

According to an aspect of the invention, if the object pixel value calculated by the shading data calculation part is smaller than the average of the neighboring pixels of the objective pixel, as calculated by the average calculation part, by more than a predetermined threshold, the adjustable processing part decreases the objective pixel value calculated by the average calculation part to approximately a half thereof.

According to another aspect of the present invention, a pollution occurrence judging device comprises a shading data calculation part to calculate shading data by scanning a white standard sheet, an average calculation part to calculate an average between an object pixel and neighboring pixels of the object pixels based on the shading data calculated by the shading data calculation part, a comparison part to comparing a value of the object pixel, calculated by the shading data calculation part, to the average of values of the neighboring pixels, calculated by the average calculation part, and an adjustment which adjusts that contamination has occurred on a line when an absolute value of the difference as a result of comparison of the comparison part is greater than a threshold.

According to the aspect of the invention, when the object pixel value calculated by the shading data calculation part is smaller than the average of the neighboring pixels, as calculated by the average calculation part, by more than the threshold, the judgment part judges that there is contamination on the object pixel.

According to still another aspect of the present invention, a method to generate a scanned image, comprises calculating shading data by scanning a white standard sheet, calculating an average between an object pixel and neighboring pixels of the object pixel based on the calculated shading data, comparing a value of the object pixel to the average of values of the neighboring pixels, adjusting the object pixel value according to a result of the comparing, and filtering such that the adjusted object pixel value gradually changes with respect to the values of the neighboring pixels.

According to this aspect of the invention, if the calculated object pixel value is smaller than the average of values of the neighboring pixels, by more than a predetermined threshold adjusting decreases the calculated average to approximately a half thereof.

Accordingly, the pollution occurrence judging device judges that contamination, such as dust or foreign substances, occurs on a certain spot of a line using a white shading correction function. Furthermore, the scanned image generating device is able to remove a black line generated during formation of a scan image, using the white shading correction function.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically shows the structure of a general scanner;

FIG. 2 schematically shows a conveyance path for transferring a document of the scan image generating device of FIG. 1;

FIG. 3 shows an example of a scanning area that a scanning head can cover at one time of scanning work;

FIG. 4 is a schematic block diagram illustrating a scan image generating device according to an embodiment of the present invention;

FIG. 5 is a flowchart illustrating a method for generating a scan image by the scan image generating device of FIG. 4; and

FIGS. 6A and 6B illustrates an effect according to FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

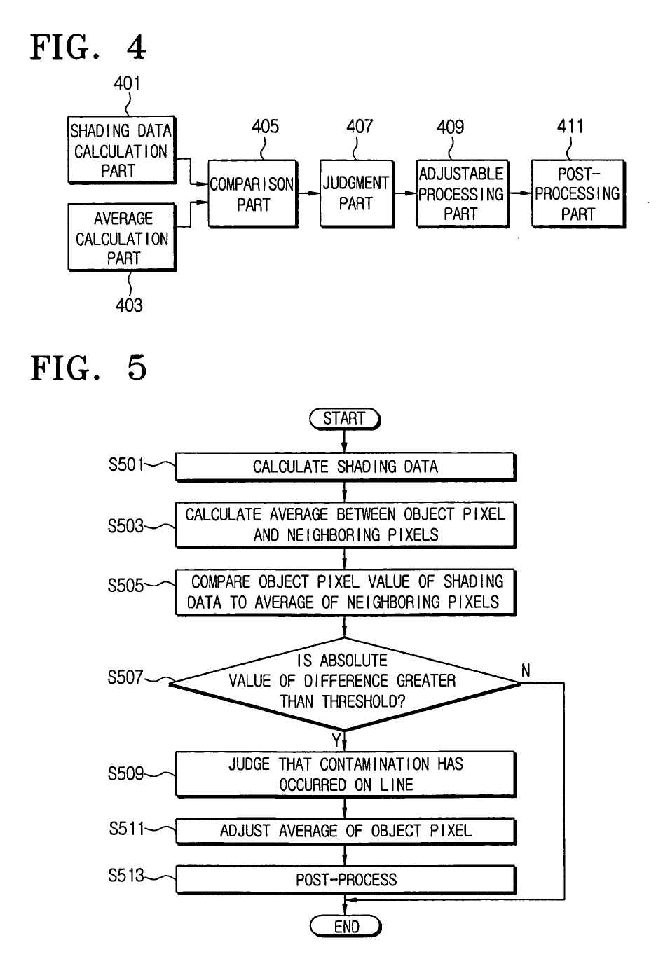

FIG. 4 is a block diagram that schematically shows a scanned image generating device according to an embodiment of the present invention. Referring to FIG. 4, the scanned image generating device comprises a shading data calculation part 401, an average calculation part 403, a comparison part 405, a judgment part 407, an adjustable processing part 409, and a post-processing part 411. The shading data calculation part 401, the average calculation part 403, the comparison part 405, and the judgment part 407 are taken altogether as a pollution occurrence judging device.

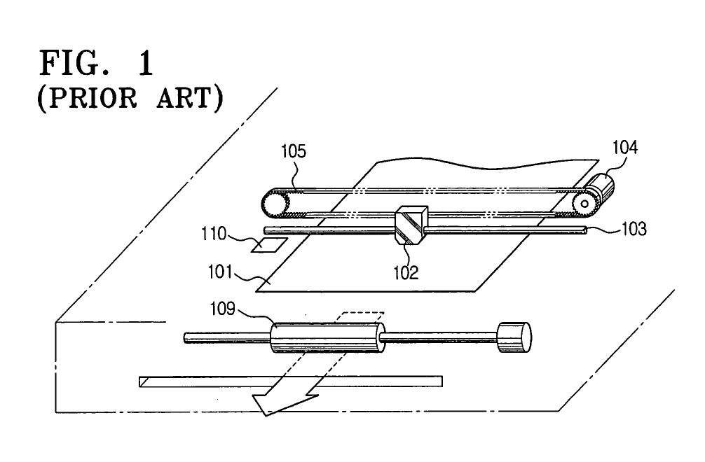

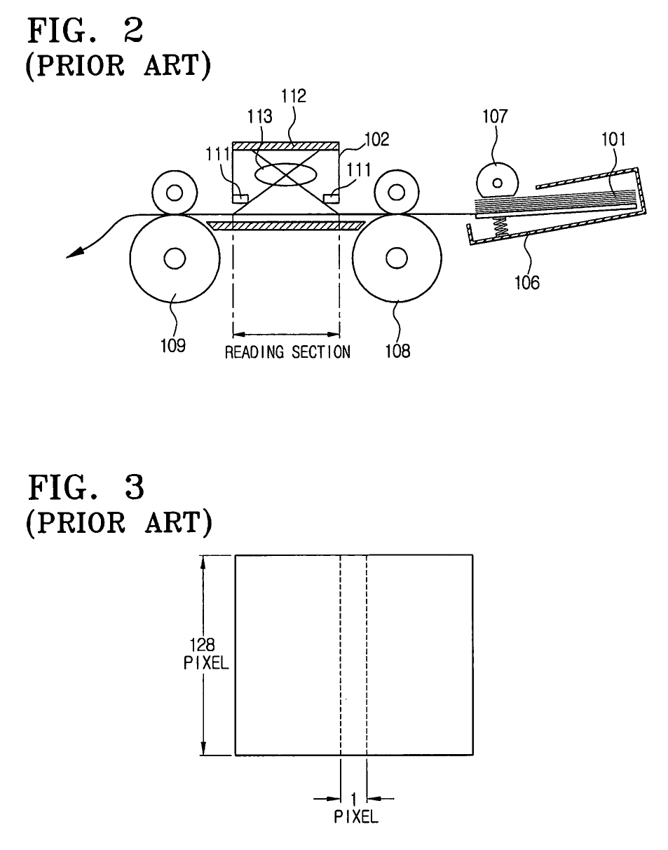

The shading data calculation part 401 scans a white standard sheet and calculates shading data. The white standard sheet 110 refers to a standard sheet attached at a position that is out of range of the valid reading area of the scanning head 102, and is recorded with a standard pattern of a predetermined form so that the scanning head 102 may read the data on the sheet 110, as shown in FIG. 1.

The average calculation part 403 calculates an average of an object pixel and neighboring pixels based on the shading data calculated by the shading data calculation part 401. The object pixel refers to a pixel being currently scanned, in other words, a pixel of interest. The object pixel value among the shading data calculated by the shading data calculation part 401 is replaced by the average calculated by the average calculation part 403.

The comparison part 405 compares the object pixel value calculated by the shading data calculation part 401 to an average of the pixels located on the left and the right of the object pixel, which is calculated by the average calculation part 403. More specifically, the comparison part 405 compares the object pixel value to the average of pixels neighboring the object pixel to determine whether there is a difference between the object pixel value and the average of pixels neighboring the object pixel. The comparison part 405 may also compare an absolute value of the difference to a certain threshold.

If the absolute value of the difference is greater than the threshold, the judgment part 407 judges that contamination has occurred on a line. Specifically, when the object pixel value is smaller than the average of the neighboring pixels of the object pixel, which is calculated by the average calculation part 403, by more than the threshold, the judgment part 403 judges that there is contamination on the object pixel.

The adjustable processing part 409 adjusts and processes the average that is calculated by the average calculation part 403 according to the comparison result of the comparison part 405. When the object pixel value of the shading data differs from values of the neighboring pixels due to the contamination on the line calculated by the shading data calculation part 401, the adjustable processing part 409 increases or decreases the average calculated by the average calculation part 403 so as to replace the shading data of the object pixel, which is calculated by the shading data calculation part 401.

Therefore, the shading data is properly corrected. If the object pixel value as calculated by the shading data calculation part 401 is smaller than the average of the neighboring pixels of the object pixel, as calculated by the average calculation part 403, by more than a predetermined threshold, the adjustable processing part 409 decreases the average calculated by the average calculation part 403, which is the replaced object pixel value, to approximately a half thereof. This value is determined to be used because the average is usually smaller than the values of the neighboring pixels in most cases of deterioration of the scan image due to the contamination.

The post-processing part 411 performs filtering such that the object pixel value adjusted by the adjustable processing part 409 gradually changes with respect to the values of the neighboring pixels.

FIG. 5 is a flowchart to illustrate a method to generate a scan image by the scan image generating device of FIG. 4. Referring to FIG. 5, the operation of the scan image generating device according to one embodiment of the present invention will be described in great detail.

The shading data calculation part 401 scans the white standard sheet to calculate the shading data (501). The shading data refers to data to correct a shading phenomenon. Generally, the shading phenomenon occurs in image pickup tubes such as a video, and a cathode ray tube (CRT), where brightness of a screen varies according to screen portions of the image pickup tube. This is caused when targets are uneven, or when secondary electron from the target is re-spread to the target. The deteriorated image quality may be improved upon by providing an adjusting electromagnetic lens. Recently, the concept of the shading phenomenon is also applied to image inputting devices such as image scanning devices, and not limited to display devices as the above.

When general documents or aerophotos are digitalized so as to generate digital image data to be used by computers, a corner portion of a screen may be darkened or distorted, and the shading correction corrects the above problems. The shading correction may divide the screen into several small areas and determine a conversion operation of density with respect to the respective small areas so as to correct a density of the screen such that a brightness of the whole screen is evened out. Alternatively, obtaining the shading data during a dummy scanning may perform the shading correction.

In this embodiment, the latter method is adopted. According to this method, the white standard sheet 110 (FIG. 1) that is attached to the scan image generating device is scanned with a lamp turned on, to calculate white shading data.

The average calculation part 403 calculates the average of an object pixel and neighboring pixels based on the shading data calculated by the shading data calculation part 401 (503). The average of the neighboring pixels of the object pixel, calculated by the average calculation part 403, replaces the shading data of the object pixel, calculated by the shading data calculation part 401.

The comparison part 405 compares the shading data calculated by the shading data calculation part 401 to the average of the neighboring pixels of the object pixel (505).

When the absolute value of the difference between the shading data and the average is greater than the threshold as a result of comparison of the comparison part 405 (507), the judgment part 407 judges that contamination has occurred on the line (509). If the object pixel value, which is the shading data calculated by the shading data calculation part 401, is smaller than the average of neighboring pixel values among averages calculated by the average calculation part 403 by more than the threshold, the adjustable processing part 409 adjusts the object pixel value replacing the shading data of the object pixel, calculated by the average calculation part 403 (511).

The post-processing part 411 performs filtering such that the object pixel value adjusted by the adjustable processing part 409 gradually changes with respect to the values of the neighboring pixels (513). In other words, the post-processing part 411 performs a median filtering with respect to the shading data being replaced with the average calculated by the average calculation part 403 and corrected, so as to restrain influences caused by significant difference between the object pixel value and the neighboring pixel values.

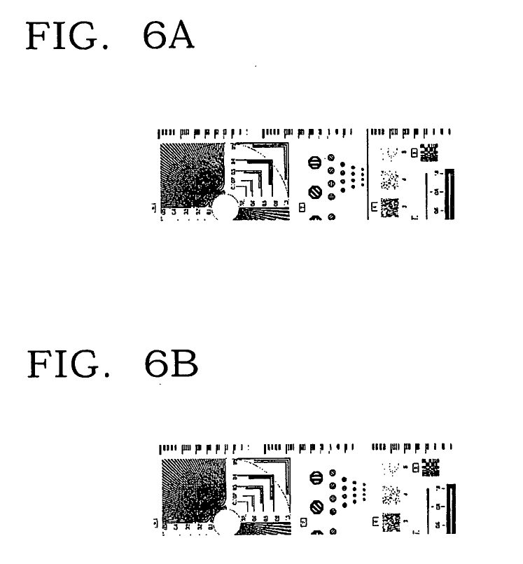

As a result, the scanned image generating device according to an embodiment of the present invention may effectively prevent influences due to the contamination such as dust or foreign substances occurring on a certain spot of the line, thereby enabling a high-quality scan image. Effects of the embodiment of the present invention are shown in FIG. 6. While a black line is caused due to the contamination on the line in the conventional scan image generating device, as shown in FIG. 6A, the scan image generating device according to an embodiment of the present invention can effectively prevent the influences of the black line when the contamination occur on the line, as shown in FIG. 6B. Accordingly, a high-quality scan image may be implemented.

Although a few embodiments of the present invention have been shown and described, it would be appreciated by those skilled in the art that changes may be made in these embodiments without departing from the principles and spirit of the invention, the scope of which is defined in the claims and their equivalents.

1. A scanned image generating device, comprising:
a shading data calculation part to calculate shading data by scanning a white sheet;
an average calculation part to calculate an average between an object pixel and neighboring pixels of the object pixel based on the shading data calculated by the shading data calculation part;
a comparison part to compare a value of the object pixel, calculated by the shading data calculation part, to the average of values of the neighboring pixels, calculated by the average calculation part;
an adjustable processing part to adjust the object pixel value calculated by the average calculation part, according to a result of comparison of the comparison part; and
a filtering post-processing part such that the object pixel value adjusted by the adjustable processing part gradually changes with respect to the values of the neighboring pixels.

2. The scan image generating device of claim 1, wherein, if the calculated object pixel value calculated by the shading data calculation part is smaller than the calculated average of the neighboring pixels of the objective pixel, calculated by the average calculation part, by more than a predetermined threshold, the adjustable processing part decreases the objective pixel value calculated by the average calculation part to by approximately a half thereof.

3. A pollution occurrence judging device, comprising:
a shading data calculation part to calculate shading data by scanning a white sheet;
an average calculation part to calculate an average between an object pixel and neighboring pixels of the object pixel based on the shading data calculated by the shading data calculation part;
a comparison part to compare a value of the object pixel, calculated by the shading data calculation part, to the average of values of the neighboring pixels, calculated by the average calculation part; and
an adjustment part, which adjusts the calculated average according to the comparison result when contamination, in which an absolute value of the difference as a result of comparison of the comparison part is greater than a threshold, has occurred.

4. The pollution occurrence judging device of claim 3, wherein, when the object pixel value calculated by the shading data calculation part is smaller than the average of the neighboring pixels, calculated by the average calculation part, by more than the threshold, the judgment part judges that contamination on the object pixel has occurred.

5. A method to generate a scanned image, comprising:
calculating shading data by scanning a white sheet;
calculating an average between an object pixel and neighboring pixels of the object pixel based on the calculated shading data;
comparing the calculated value of the object pixel, to the average of values of the neighboring pixels;
adjusting the calculated object pixel value according to a result of the comparing; and
filtering such that the adjusted object pixel value gradually changes with respect to the values of the neighboring pixels.

6. The method of claim 5, wherein, if the calculated object pixel value is smaller than the calculated average of values of the neighboring pixels by more than a predetermined threshold, the adjusting decreases the calculated average to approximately a half thereof.

7. A scanned image generating device, comprising:
a shading data calculator to calculate shading data by scanning a sheet to obtain respective shading values of an object pixel and neighboring pixels of the object pixel;
an average calculator to calculate an average between the shading value of the object pixel and the shading values of the neighboring pixels;
a comparator to compare the shading value of the object pixel to the average calculated by the average calculator;
an adjustable processor to adjust the shading value of the object pixel according to a result of the comparison; and
a filtering post-processor such that the adjusted shading value of the object pixel gradually changes with respect to the values of the neighboring pixels.

8. A pollution occurrence judging device of a scanned image generating device, comprising:
a shading data calculator to calculate shading data, including a shading value of an object pixel and shading values of neighboring pixels, by scanning a sheet;
an average calculator to calculate an average between the shading values of the object pixel and the neighboring pixels;
a comparator to compare the shading value of the object pixel to the average calculated by the average calculator; and
an adjustor, which adjusts the calculated average according to the comparison result when contamination, in which an absolute value of the difference as a result of comparison of the comparison part is greater than a threshold, has occurred.

9. A method to generate a scanned image, comprising:
calculating shading data, including a shading value of an object pixel and shading values of neighboring pixels, by scanning a white sheet;
calculating an average between the shading value of the object pixel and the shading values of the neighboring pixels;
comparing the shading value of the object pixel to the average between the shading value of the object pixel and the shading values of the neighboring pixels;
adjusting the calculated object pixel value according to a result of the comparing; and
filtering such that the adjusted shading value of the object pixel value gradually changes with respect to the values of the neighboring pixels.
